(19) United States
(12) Patent Application Publication
(10) Pub. No.: US 2025/0142686 A1
(43) Pub. Date: May 1, 2025

(54) Method for the Safe Operation of a Combination Cooking Appliance and Combination Cooking Appliance

(71) Applicant: RATIONAL Aktiengesellschaft, Landsberg am Lech (DE)

(72) Inventors: Christian KOENEN, Landsberg am Lech (DE); Eugen ENGELMANN, Landsberg am Lech (DE); Peter MÜLLER, Landsberg am Lech (DE); Peter SELIG, Landsberg am Lech (DE)

(21) Appl. No.: 18/927,665

(22) Filed: Oct. 25, 2024

(30) Foreign Application Priority Data
Oct. 25, 2023 (DE) 10 2023 129 436.9

(51) Int. Cl. H05B 6/64

(52) U.S. Cl. CPC H05B 6/6452; H05B 6/6476

(57) ABSTRACT

A combination cooking appliance has a cooking chamber and a microwave source with a microwave power. In a method for the safe operation of the combination cooking appliance, a cooking chamber temperature prevailing in the cooking chamber is detected, and a convection-relevant parameter is determined. The detected cooking chamber temperature and the convection-relevant parameter are evaluated to determine a maximum permissible microwave power. The microwave power of the microwave source is limited to the maximum permissible microwave power.

The invention relates to a method for the safe operation of a combination cooking appliance. The invention also relates to a combination cooking appliance.

### BACKGROUND OF THE INVENTION

In addition to a heating device for generating hot air, cooking appliances used in professional or large-scale gastronomy typically also have a steam generator for generating steam to cook a cooking product placed in the cooking chamber of the cooking appliance. The heating device and the steam generator create a cooking chamber atmosphere in the cooking chamber, which may also be referred to as cooking chamber climate. A cooking product exposed to the cooking climate in the cooking chamber is cooked accordingly by the latter in that energy is introduced into the cooking product by convection.

In addition to the heating device and the steam generator, such cooking appliances may also have a microwave source which serves to accelerate the cooking process by introducing (additional) energy in the form of microwaves into the cooking product. Generally, cooking appliances which have a microwave source in addition to a heating device and an optional steam generator are also referred to as combination cooking appliances.

It has been found that when there is no cooking product in the cooking chamber, the microwave radiation fed into the cooking chamber primarily interacts with the cooking chamber itself, i.e. it couples into components of the cooking appliance which border the cooking chamber, such as the cooking chamber walls or a window in a cooking chamber door. However, the microwave radiation can also be partially absorbed by components in the cooking chamber which have been added, for example cooking accessories or a core temperature probe, in particular a cable of a wired core temperature probe.

Depending on the material and composition of the components, the absorption of the microwave radiation fed into the cooking chamber may cause damage to the components. To avoid such damage, the prior art proposes to equip cooking appliances with automatic safety shutdown mechanisms. These detect idle operation, i.e. the operation of the cooking appliance with an empty cooking chamber, whereupon the microwave supply is automatically switched off.

Document DE 10 2004 015 993 A1, for example, discloses a microwave oven which automatically detects idle operation and automatically switches off a device for generating microwaves when idle operation of the cooking appliance has been detected.

However, it has been found that under certain circumstances, even with small or even medium loads of the cooking appliance, wear or damage to components of the cooking appliance may occur, i.e. when microwave operation is basically permitted. The wear or damage is undesirable because the corresponding components have to be replaced early, which increases costs.

In this respect, the object of the present invention is to eliminate the disadvantages of the prior art and to provide a method by which a cooking appliance can be operated safely.

### BRIEF DESCRIPTION OF THE INVENTION

According to the invention, the object is achieved by a method for the safe operation of a combination cooking appliance having a cooking chamber and a microwave source with a microwave power, the method comprising the steps of:
detecting a cooking chamber temperature prevailing in the cooking chamber,
determining a convection-relevant parameter, evaluating the detected cooking chamber temperature and the convection-relevant parameter to determine a maximum permissible microwave power, and
limiting the microwave power of the microwave source to the maximum permissible microwave power, in particular to a maximum permissible microwave power for the detected cooking chamber temperature and the determined convection-relevant parameter.

The invention is based on the basic idea that the combination cooking appliance can be operated safely with the microwave source by limiting the microwave power of the microwave source to the maximum permissible microwave power for the determined convection-relevant parameter and the detected cooking chamber temperature.

The maximum permissible microwave power may therefore be lower than the generally possible microwave power (nominal power of the microwave source). The actual maximum permissible microwave power thus depends on the detected cooking chamber temperature and the determined convection-relevant parameter. In other words, the maximum permissible microwave power is specified in terms of control, namely as a function of the detected cooking chamber temperature and the determined convection-relevant parameter. The maximum permissible microwave power is therefore variable, in particular during a cooking process, as the cooking chamber temperature and/or the convection-relevant parameter vary during the cooking process.

This allows the energy in the form of microwaves fed into the cooking chamber to be limited, as a result of which less microwave energy can interact with the components of the combination cooking appliance, thus effectively preventing damage to the components due to the microwaves.

It has been found that the energy of the microwaves can couple into components of the combination cooking appliance which are present in or delimit the cooking chamber, which heats these components. This resulted in increased wear or even damage to the components, which is now effectively prevented, enabling reliable and safe operation of the combination cooking appliance. The components present in the cooking chamber are, in particular, wired core temperature probes which should not exceed a certain temperature.

If convection takes place at the respective component, i.e. if air flows around the component, it can be cooled by the latter, which is why the component heats up less. With strong convection or air circulation around the component, more thermal energy can be removed than with low convection. If more thermal energy can be removed, i.e. if there is more convection, more microwave energy can generally be fed in under otherwise identical conditions. For this reason, the convection-relevant parameter is also determined and taken into account in the evaluation in addition to the cooking chamber temperature.

Both parameters, i.e. the cooking chamber temperature prevailing in the cooking chamber and the convection-relevant parameter, therefore influence how high the energy input from microwaves may still be, from which the maximum permissible microwave power of the microwave source can be determined. Based on these parameters, i.e. the cooking chamber temperature and the convection-relevant parameter, it is possible to determine or estimate the maximum amount of energy that the respective component may still absorb without being damaged. In this way, a maximum permissible microwave power can be determined for the operating state. The operating state is determined by the cooking chamber temperature and the convection-relevant parameter.

In other words, it can be determined what the maximum additional energy input from the microwave source into the component may be so that a threshold or limit value for the temperature of the component is not reached and/or exceeded.

The actual maximum microwave power which can be introduced, and which is defined by the maximum permissible microwave power, can therefore be closed-loop controlled depending on the cooking chamber temperature and the convection-relevant parameter.

In contrast to the safety shutdowns known from the prior art, which merely provide to completely stop microwave operation, the method according to the invention provides to regulate or reduce the microwave power of the microwave source, if necessary. According to the invention, the (theoretically possible) microwave power of the microwave source, i.e. the nominal power, is therefore reduced to the maximum permissible microwave power (situationally), instead of being completely set to zero. A situational reduction is understood to be a reduction which depends on the detected or determined parameters, namely the cooking chamber temperature and the convection-relevant parameter. The combination cooking appliance can thus be operated safely without necessarily switching off the microwave source. In other words, microwave operation of the combination cooking appliance is still possible.

The maximum permissible microwave power depends in particular on the component taken into account. If several components are taken into account, the maximum permissible microwave power may be selected based on the component which allows the lowest maximum permissible microwave power. This ensures that none of the components considered are damaged. In this respect, a global maximum permissible microwave power can be determined.

In other respects, the loading state of the combination cooking appliance may not play any role in the closed-loop control of the microwave power, so that there is a closed-loop control of the microwave power which is independent of the loading of the combination cooking appliance. Instead of using the loading as an additional parameter, the convection-relevant parameter is used, which allows a statement to be made about any cooling effect of the component due to convection.

During evaluation, a maximum permissible energy input into a component of the combination cooking appliance and/or a maximum permissible temperature of a component of the combination cooking appliance may be taken into account. The maximum permissible microwave power is determined such that during operation of the microwave source at the maximum permissible microwave power, the maximum permissible energy input into the component of the combination cooking appliance and/or the maximum permissible temperature of the component of the combination cooking appliance is/are not exceeded.

The maximum permissible energy input is understood to be the input of energy which may be supplied to a component of the combination cooking appliance without the component being damaged by the absorption of the energy or reaching the maximum permissible temperature.

The maximum permissible temperature is understood to be the temperature which a component of the combination cooking appliance should not exceed, especially during operation of the microwave source at the maximum permissible microwave power, for example with an empty cooking chamber.

The component of the combination cooking appliance may be any component or part of the combination cooking appliance within the cooking chamber, for example a cooking chamber wall, a core temperature probe provided in the cooking chamber, a cable of the core temperature probe, a sensor, a frame, a light and/or a viewing window of the cooking chamber door, in particular a window pane. The components of the combination cooking appliance all have a maximum permissible energy input or a maximum permissible temperature, above which damage to the components may occur. The maximum permissible energy input is therefore individual for each of the components. This applies equally to the maximum permissible temperature.

For example, the maximum permissible temperature for the core temperature probe, in particular the cable thereof, is the melting point of a sheathing. In the case of the viewing window of the cooking chamber door, the transition temperature of the pane installed in the viewing window, in particular the glass pane, may be defined as the maximum permissible temperature.

By taking the maximum permissible energy input and/or the maximum permissible temperature into account, damage to a component during operation can in this way be easily prevented.

One aspect provides that the cooking chamber temperature is detected by a temperature sensor arranged in a core temperature probe and/or that the cooking chamber temperature is detected by a temperature sensor arranged in the cooking chamber of the combination cooking appliance. The temperature sensor may be provided in a handle section or a measuring section of the core temperature probe. If the core temperature probe is in a park position, i.e. is not inserted into the cooking product, any temperature sensor of the core temperature probe can be used, provided that it is not thermally isolated in the park position. If the core temperature probe is inserted into a cooking product, i.e. is in use, the temperature sensor provided in the handle section can still be used. Alternatively or additionally, a temperature sensor can be used which is assigned to the cooking chamber but is provided outside the core temperature sensor.

Furthermore, the determined convection-relevant parameter may be a rotational speed of a fan wheel, a rotating velocity of a fan wheel, a volume per time unit of air exchanged in the cooking chamber or a circulating flow in the cooking chamber. In particular, the rotational speed of the fan wheel is detected by sensors, based on which the rotating velocity, the volume per time unit of air exchanged in the cooking chamber or the circulation flow in the cooking chamber is then determined. However, the sensor-detected rotational speed of the fan wheel can also be taken into account directly during the evaluation to then determine the maximum permissible microwave power based on the rotational speed, among other things.

A further aspect provides that a model, a functional relationship or a table, has been determined, in particular empirically, on the basis of which the maximum permissible microwave power is determined as a function of the convection-relevant parameter and the cooking chamber temperature. The model, the functional relationship or the table is determined in particular for the respective component. If several components are involved to limit the microwave power of the microwave source depending on the situation, several models, functional relationships or tables are used accordingly.

The model, functional relationship or table is preferably based on data determined in advance. For example, the data has been obtained from test series in which the influence of varying microwave power on a cooking chamber with different convection-relevant parameters and/or different cooking chamber temperatures is analyzed. A maximum permissible microwave power which may be fed into the cooking chamber without exceeding a maximum permissible energy input into a component of the combination cooking appliance and/or a maximum permissible temperature of a component of the combination cooking appliance may be determined empirically for different combinations of a convection-relevant parameter and a cooking chamber temperature. The data thus obtained can be used as the basis for the model, the functional relationship or the table to determine, on the basis thereof, the maximum permissible microwave power as a function of the convection-relevant parameter and the cooking temperature, i.e. as a function of the operating state of the combination cooking appliance, which is determined, among other things, via the convection-relevant parameter and/or the cooking chamber temperature.

In particular, at least one predetermined threshold value is provided for the convection-related parameter, exceeding and/or undershooting the threshold value resulting in a modified dependency of the maximum permissible microwave power. For example, the threshold value may be provided for the rotational speed of the fan wheel, as convection, which results in cooling of the component, only occurs above a certain rotational speed. At a certain rotational speed of the fan wheel, such a large convection may also already be present that a higher rotational speed would no longer result in a better cooling. Furthermore, there may be a different threshold value depending on the respective component. The respective threshold value may have been determined empirically. For the sheathing of a core temperature probe, in particular the cable thereof, a threshold value of 1,000 revolutions per minute (rpm) may be specified for the rotational speed of the fan. The dependency of the maximum permissible microwave power on the rotational speed of the fan, which serves as a convection-relevant parameter, is therefore different below a speed of 1,000 rpm than at a rotational speed above 1,000 rpm.

For example, the maximum permissible microwave power is determined via the detected cooking chamber temperature and a microwave factor, which depends on the at least one predetermined threshold value. The threshold value may therefore initially be used to determine a microwave factor, which in turn is used to calculate the maximum permissible microwave power. In particular, the microwave factor depends linearly on the at least one predetermined threshold value when the value falls below the at least one predetermined threshold value, whereas the microwave factor is otherwise a constant, i.e. when the at least one predetermined threshold value is exceeded.

For example, the dependency of the microwave factor MW_{factor} is as follows when the predetermined threshold value for the convection-relevant parameter is undershot:

$$M {W}_{factor} = {Prop}_{factor} * {Parameter}_{convection - relevant} + Offset ,$$

where Prop_{factor} is a proportionality factor which has been determined empirically or simulated, for example, Parameter_{convection-relevant} is the convection-relevant parameter, and Offset is a compensating value which determines the microwave factor when the convection-relevant parameter is 0.

In contrast thereto, the microwave factor MW_{factor} is a constant (const.) if the predetermined threshold value for the convection-relevant parameter is exceeded:

MW_{factor}=const.

Furthermore, a temperature limit may be provided, the maximum permissible microwave power being zero if the detected cooking chamber temperature reaches the temperature limit. This provides an additional level of safety, as it is ensured that no additional microwave energy is introduced if the cooking chamber temperature is already so high that the maximum permissible temperature of the component of the combination cooking appliance should already have been reached or there is only a difference between the cooking chamber temperature and the maximum permissible temperature of the component which is smaller than a safety margin. The temperature limit may be 300° C. In this respect, further microwave energy must not be introduced into the cooking chamber above a cooking chamber temperature of 300° C.

In particular, it is provided that the microwave source is operated at most at the maximum permissible microwave power so that microwaves generated by the microwave source are fed into the cooking chamber. The actual maximum microwave power that can be introduced is therefore changed depending on the situation. The microwave source can be operated at a microwave power which is lower than the maximum permissible microwave power. In any case, the microwave power output by the microwave source cannot exceed the maximum permissible microwave power.

The maximum permissible microwave power may be greater than or equal to 0% and less than or equal to 100% of the nominal power of the microwave source. The entire nominal power of the microwave source can therefore be utilized, provided that this is permitted by the operating state of the combination cooking appliance (and a power connection of the combination cooking appliance). In other words, the maximum permissible microwave power may be between 0% and 100% of the nominal power of the microwave source, depending on the operating state of the combination cooking appliance, which depends on the detected cooking chamber temperature and the convection-relevant parameter.

A further aspect provides that the maximum permissible microwave power is determined several times during a cooking process, in particular regularly or periodically. Thus, the current operating state of the combination cooking appliance is constantly monitored, which results in a (regular or periodic) adjustment of the maximum permissible microwave power.

A control unit for the combination cooking appliance may take the maximum permissible microwave power, which has been previously determined, into account when activating the microwave source, in particular when setting the power for the microwave source. As explained above, the maximum permissible microwave power is not necessarily the actual microwave power of the microwave source, but a limit which must not be exceeded or cannot be exceeded (in terms of control).

When running a cooking program, it may be provided that the control unit of the combination cooking appliance can also take the specifications for the cooking chamber temperature (desired cooking chamber temperature) and the convection-relevant parameter (desired value for the convection-relevant parameter) into account. This allows the cooking process to be adjusted, for example a cooking time adjustment, provided that it is determined that the maximum permissible microwave power is low for a certain period of time, so that it is not possible to shorten the cooking time by introducing additional microwave energy.

Furthermore, the invention relates to a combination cooking appliance for cooking a cooking product. The combination cooking appliance comprises a cooking chamber, a microwave source associated with the cooking chamber for feeding microwaves with a specific microwave power into the cooking chamber, a temperature sensor for detecting a cooking chamber temperature and at least one sensor for detecting a convection-relevant parameter. The combination cooking appliance has an evaluation unit which is connected in a signal-transmitting manner to the temperature sensor and to the at least one sensor. The evaluation unit is set up to determine a maximum permissible microwave power for the microwave source based on the cooking chamber temperature detected by the temperature sensor and the convection-relevant parameter determined by the sensor. The combination cooking appliance has a control unit which is connected in a signal-transmitting manner to the evaluation unit and the microwave source. The control unit is set up to receive the maximum permissible microwave power determined by the evaluation unit and to limit the microwave power of the microwave source on the basis thereof. The combination cooking appliance is basically configured and set up to carry out the aforementioned method. The corresponding properties and advantages arise in a similar way for the combination cooking appliance.

As already explained above, the microwave source is driven by the control system such that the actual microwave power is less than or equal to the maximum permissible microwave power, which depends on the operating state of the combination cooking appliance. In case of a change in the operating state, i.e. the cooking chamber temperature and/or the convection-relevant parameter, this thus also results in a different maximum permissible microwave power.

In particular, the maximum permissible microwave power is determined several times during a cooking process, in particular regularly or periodically.

### BRIEF DESCRIPTION OF THE DRAWINGS

Further advantages and features of the invention will become apparent from the description below and from the drawings, to which reference is made and in which:

FIG. 1 shows a schematic representation of a combination cooking appliance according to the invention,

FIG. 2 shows the steps of a method according to the invention for the safe operation of the combination cooking appliance of FIG. 1, and

FIG. 3 shows an overview illustrating the maximum permissible microwave power as a function of the cooking chamber temperature and the convection-relevant parameter.

### DETAILED DESCRIPTION OF THE INVENTION

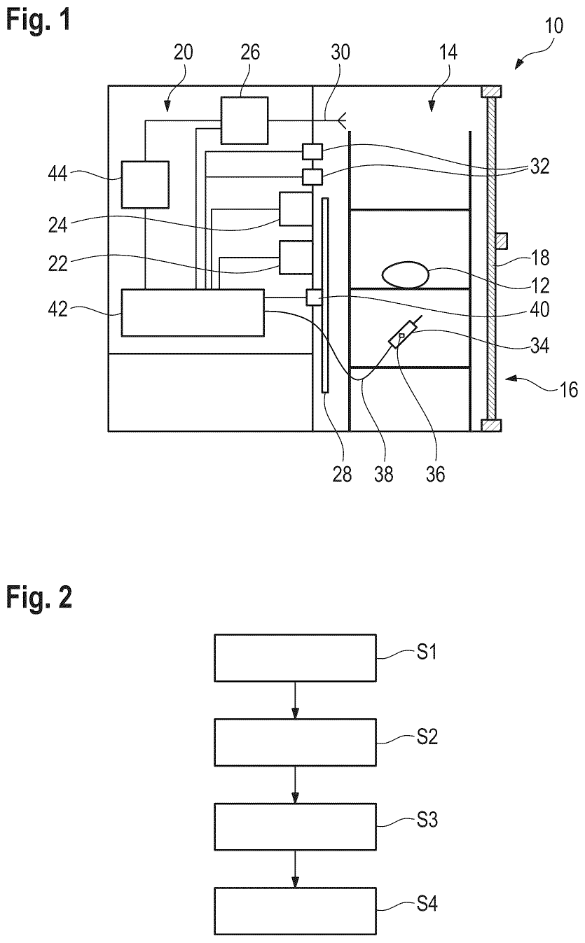

FIG. 1 shows a combination cooking appliance 10 for cooking a cooking product 12 which has been placed in a cooking chamber 14 of the combination cooking appliance 10 to be cooked there.

Furthermore, the cooking chamber 14 has a cooking chamber door 16 assigned thereto which seals the cooking chamber 14 from the environment so that a defined cooking chamber climate can be generated inside the cooking chamber 14 for cooking the cooking product 12. The cooking chamber door 16 also has a viewing window 18, which serves to ensure an unobstructed view of the cooking product 12 from the outside during the cooking process. The viewing window 18 is in particular a glass pane.

A technical compartment 20 is provided separated from the cooking chamber 14, in which, among other things, components are at least partially accommodated which are necessary for generating and adjusting the cooking chamber climate, i.e. a cooking chamber atmosphere, in the cooking chamber 14, or which provide the energy for cooking the cooking product 12.

In the embodiment shown, the combination cooking appliance 10 comprises a heating device 22, a steam generator 24, a microwave source 26 and a fan wheel 28.

The steam generator 24 and the heating device 22 are at least partially accommodated in the technical compartment 20 and serve, among other things, to provide the defined cooking chamber atmosphere in the cooking chamber 14, in particular the cooking chamber temperature and humidity. The cooking chamber atmosphere or cooking chamber climate generated in the cooking chamber 16 is thus defined, among other things, as a specific temperature in combination with a specific humidity. In addition, a flow rate and/or pressure can be provided with respect to the cooking chamber atmosphere, provided that the fan wheel 28 is operated accordingly. Basically, the fan wheel 28 can also contribute to the cooking chamber atmosphere or the cooking chamber climate, as it is used to set a convection within the cooking chamber 14.

The microwave source 26 has at least one antenna 30 which faces the cooking chamber 14 to couple microwaves generated by the microwave source 26 into the cooking chamber 14 and thus to apply (additional) energy to the cooking product 12.

The combination cooking appliance 10 also has at least one cooking chamber temperature sensor 32, which is set up to measure the cooking chamber temperature in the cooking chamber 14. The cooking chamber temperature sensor 32 can also be referred to as cooking chamber sensor. In the illustrated example embodiment, two cooking chamber temperature sensors or cooking chamber sensors 32 are shown, which may in particular be arranged so as to be distributed in the cooking chamber 14. A mean value of the cooking chamber temperatures detected by the respective cooking chamber sensors 32 is then for example used for the further processing.

In addition, a core temperature probe 34 is provided in the cooking chamber 14, which has at least one temperature sensor 36.

If the core temperature probe 34 is not inserted into the cooking product 12, the temperature sensor 36, which is integrated in the core temperature probe 34, could also be used to detect a cooking chamber temperature prevailing in the cooking chamber 14, in particular, as an alternative, if the cooking chamber sensor 32 fails.

The cooking chamber temperature prevailing in the cooking chamber 14 can therefore be detected using the cooking chamber sensor 32 and/or the core temperature probe 34, in particular the temperature sensor 36 thereof.

In the embodiment shown, the core temperature probe 34 is a wired core temperature probe which has a cable 38 arranged in the cooking chamber 14, which, like the core temperature probe 34 itself, is exposed to the cooking chamber climate, i.e. the cooking chamber temperature.

In addition, a sensor 40 is assigned to the fan wheel 28, via which a convection-relevant parameter can be determined. The sensor 40 can be set up to measure the rotational speed of the fan wheel 28, which corresponds to the convection-relevant parameter, since the convection generated by the fan wheel 28 depends on the rotational speed thereof.

Furthermore, the combination cooking appliance 10 has an evaluation unit 42 which is arranged in the technical compartment 20 and is in a signal-transmitting connection with the above-mentioned components, in particular the cooking chamber sensor 32, the core temperature probe 34 and the sensor 40. In this respect, the evaluation unit 42 is set up to receive and evaluate information from the above-mentioned components, i.e. the cooking chamber temperature and the convection-relevant parameters such as the rotational speed.

The evaluation unit 42 can also be set up to determine another convection-relevant parameter based on the rotational speed detected by the sensor 40, for example a rotating velocity of the fan wheel 28, a volume per time unit of exchanged air in the cooking chamber 14 or a circulating flow in the cooking chamber 14. Alternatively or additionally, a different type of sensor can be used to directly detect a convection-relevant parameter other than the rotational speed, for example a flow sensor arranged in the cooking chamber 14.

Generally, the evaluation unit 42 can also be connected in a signal-transmitting manner to the heating device 22, the steam generator 24 and the microwave source 26 to receive information or data from these components.

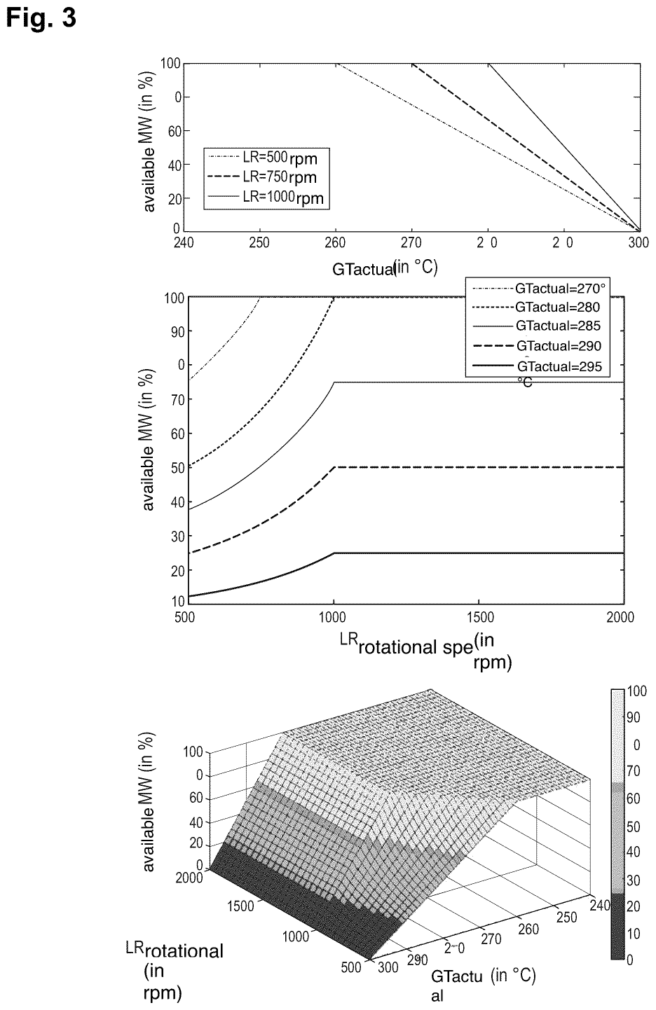

The evaluation unit 42 is generally configured and set up to evaluate the detected cooking chamber temperature and the convection-relevant parameter to determine a maximum permissible microwave power, as will be explained in more detail below with reference to FIGS. 2 and 3.

The evaluation unit 42 is also connected in a signal-transmitting manner to a control unit 44, which in turn is connected in a signal-transmitting manner at least to the microwave source 26 such that the microwave source 26 can be driven by the control unit 44. In other words, the control unit 44 is configured and set up to drive the microwave source 26, in particular depending on an evaluation result of the evaluation unit 42.

The control unit 44 is therefore set up to limit a microwave power of the microwave source 26 to the maximum permissible microwave power, as will be explained below.

The control unit 44 can also be connected in a signal-transmitting manner to the heating device 22, the steam generator 24 and/or the fan wheel 28 such that the corresponding components can be driven by the control unit 44. These corresponding connections are not shown here for the sake of clarity.

In principle, it is conceivable that the evaluation unit 42 and the control unit 44 are designed as a common combined unit, namely a control and/or evaluation unit.

The combination cooking appliance 10 is set up to carry out the method for the safe operation of the combination cooking appliance 10 according to the invention, which is explained below.

In a first step, the cooking chamber temperature prevailing in the cooking chamber 14 is detected (step S1). To do this, the cooking chamber sensor 32 and/or the core temperature probe 34 measure(s) the cooking chamber temperature prevailing in the cooking chamber 14.

The measured cooking chamber temperature is transmitted to the evaluation unit 42.

In a second step, the convection-relevant parameter is determined (step S2). For this purpose, in the present example embodiment according to FIG. 1, the sensor 40 measures the rotational speed of the fan wheel 28, which is the convection-relevant parameter.

The rotational speed is transmitted to the evaluation unit 42. The evaluation unit 42 can calculate another convection-relevant parameter based on the rotational speed detected by sensors, provided that this can be used for a later evaluation.

In a third step, the detected cooking chamber temperature and the convection-relevant parameter are evaluated by the evaluation unit 42 to determine a maximum permissible microwave power (step S3). During evaluation, the evaluation unit 42 takes a maximum permissible energy input into at least one component of the combination cooking appliance 10 and/or a maximum permissible temperature of at least one component of the combination cooking appliance 10 into account.

The maximum permissible microwave power is determined such that during operation of the microwave source 26 at the maximum permissible microwave power, the maximum permissible energy input into the component of the combination cooking appliance 10 and/or the maximum permissible temperature of the component of the combination cooking appliance 10 is/are not exceeded.

The corresponding component is, for example, the viewing window 18 or the core temperature probe 34, in particular the cable 38 of the core temperature probe 34.

In principle, several components can be taken into account when determining the maximum permissible microwave power, each component having its own individual maximum permissible microwave power. The component having the lowest individual maximum permissible microwave power then, for example, specifies the maximum permissible microwave power to ensure that no component of the combination cooking appliance 10 is damaged.

In particular, the evaluation unit 42 uses a model, a functional relationship or a table for the respective component of the combination cooking appliance 10. The model, functional relationship or table has been determined in particular on the basis of data that has been empirically determined in advance for a component of the combination cooking appliance 10. With these data, the model, the functional relationship or the table can then determine the maximum permissible microwave power as a function of the currently determined convection-relevant parameter and the currently detected cooking chamber temperature. In other words, the cooking chamber temperature and the convection-relevant parameter serve as input values, which are used by the evaluation unit 42 to determine the maximum permissible microwave power using an algorithm or a logic.

The maximum permissible microwave power is greater than or equal to 0% and less than or equal to 100% of the nominal power of the microwave source 26. This depends on the operating state of the combination cooking appliance 10, namely on the detected cooking chamber temperature and the convection-relevant parameter, for example the rotational speed.

FIG. 3 shows diagrams which illustrate how the maximum permissible microwave power depends on the temperature of the cooking chamber and the convection-relevant parameter.

In the first diagram, the maximum permissible microwave power (in %), here referred to as “available MW”, is shown against the detected cooking chamber temperature GT_{actual} (in ° C.) for three different convection-relevant parameters, namely for a rotational speed of the fan wheel 28 (“LR”) of 500 rpm, 750 rpm and >1000 rpm.

In the second diagram, the maximum permissible microwave power (in %), here referred to as “available MW”, is shown against the convection-relevant parameter in the form of the rotational speed of the fan wheel 28 LR_{rotational speed} (in rpm) for five different cooking chamber temperatures GT_{actual}, namely for cooking chamber temperatures GT_{actual} of 270° C., 280° C., 285° C., 290° C. and 295° C.

The third diagram shows a three-dimensional diagram, the maximum permissible microwave power (in %), here referred to as “available MW”, being shown against the detected cooking chamber temperature GT_{actual} (in ° C.) and the rotational speed of the fan wheel 28 LR_{rotational speed} (in rpm).

As already explained above, the maximum permissible microwave power is a limit for the microwave source 26, which does not necessarily have to correspond to the microwave power actually introduced by the microwave source 26. Rather, the theoretically possible microwave power is limited under certain circumstances, namely depending on the cooking chamber temperature and the convection-relevant parameter, as can be clearly seen from FIG. 3.

In particular, it clearly results therefrom that a temperature limit is provided, the maximum permissible microwave power being zero when the detected cooking chamber temperature reaches the temperature limit. In the illustrated example embodiment, the temperature limit is set at 300° C.

The diagrams also show that at least one predetermined threshold value is provided for the convection-relevant parameter, exceeding and/or undershooting the threshold value resulting in a modified dependency of the maximum permissible microwave power. In the illustrated example embodiment, the threshold value corresponds to a rotational speed of the fan wheel of 1,000 revolutions per minute (rpm). Above this rotational speed, i.e. the threshold value of 1,000 rpm, the maximum permissible microwave power is 100%, whereas below this rotational speed, the maximum permissible microwave power decreases as the rotational speed decreases.

The diagrams further show that there is a linear relationship between the cooking chamber temperature and the maximum permissible microwave power, the linearity in turn depending on the convection-relevant parameter, i.e. the rotational speed.

In principle, the maximum permissible microwave power can be determined from the detected cooking chamber temperature and a microwave factor which depends on the at least one predetermined threshold value. A functional relationship for the maximum permissible microwave power MWₘₐₓ can thus be achieved, which can be expressed as follows:

$$M {W}_{max} = \frac{( 300 - {GT}_{actual} )}{M {W}_{factor}} * 100 ,$$

where GT_{actual} is the detected cooking chamber temperature. In addition, the functional relationship includes the microwave factor MW_{factor}, which describes the linear dependency of the maximum permissible microwave power on the cooking chamber temperature and itself depends on the convection-relevant parameter, as already explained in the diagrams above. The microwave factor MW_{factor} can be represented as follows:

If the predetermined threshold value (1,000 rpm) for the convection-relevant parameter is undershot, the following relationship is obtained for the microwave factor MW_{factor}:

$$M {W}_{factor} = {Prop}_{factor} * {Parameter}_{convection - relevant} + Offset ,$$

where Prop_{factor} is a proportionality factor which has been determined empirically or simulated, for example, Parameter_{convection-relevant} is the convection-relevant parameter, for example the rotational speed. The parameter Offset is a compensating value which determines the microwave factor MW_{factor} when the convection-relevant parameter, for example the rotational speed, is 0.

In contrast thereto, the microwave factor MW_{factor} is a constant (const.) if the predetermined threshold value (1,000 rpm) for the convection-relevant parameter is exceeded:

$$M {W}_{factor} = const . = 20$$

In addition, it is stored in the evaluation unit that the maximum permissible microwave power has a value of 100 if the above functional relationship would result in a value greater than 100, and has a value of 0 if the above functional relationship would result in a value less than 0. It is thus ensured that the maximum permissible microwave power is between 0% and 100% of the nominal power of the microwave source 26, as already explained above.

When the evaluation unit 42 has determined the maximum permissible microwave power, this is then sent to the control unit 44.

The control 44 then limits the actually output microwave power of the microwave source 26 to the maximum permissible microwave power (step S4). The microwave source 26 can then either be driven or closed-loop controlled accordingly, or a damping element is connected which limits the microwave power. The microwave power can be open-loop or closed-loop controlled by means of pulse width modulation, in which time intervals are set between microwave pulses, for example a PWM of 20%, in particular a pulse duration of 200 ms and a pause of 800 ms. The microwave source 26 is then operated such that the actually output microwave power never exceeds the currently available maximum permissible microwave power. The actually output microwave power can also be less than the maximum permissible microwave power, since this is only a limit for the microwave source 26 which must not be exceeded to ensure that the component of the combination cooking appliance 10 is not damaged, for example a sheathing of the core temperature probe 34, in particular the cable 38.

The method described here can be used both at the start of a cooking process and at regular time intervals during the cooking process.

In other words, the maximum permissible microwave power can be determined several times during a cooking process. Initially, the operating state of the combination cooking appliance 10, i.e. the cooking chamber temperature and the convection-relevant parameter, is detected several times during the cooking process, in particular regularly or periodically, so that these values can be evaluated based thereon, to thus determine the maximum permissible microwave power. In this way, it is ensured that both efficiency and safety are maximized, since the theoretically maximum possible microwave power is adapted depending on the situation.

1. A method for the safe operation of a combination cooking appliance having a cooking chamber and a microwave source with a microwave power, the method comprising the steps of:
detecting a cooking chamber temperature prevailing in the cooking chamber,
determining a convection-relevant parameter,
evaluating the detected cooking chamber temperature and the convection-relevant parameter to determine a maximum permissible microwave power, and
limiting the microwave power of the microwave source to the maximum permissible microwave power.

2. The method of claim 1 wherein the cooking chamber temperature is detected by a temperature sensor arranged in a core temperature probe, and/or in that the cooking chamber temperature is detected by a temperature sensor arranged in the cooking chamber of the combination cooking appliance.

3. The method of claim 1 wherein the determined convection-relevant parameter is a rotational speed of a fan wheel, a rotating velocity of a fan wheel, a volume per time unit of exchanged air in the cooking chamber or a circulating flow in the cooking chamber.

4. The method of claim 1 wherein a model, a functional relationship or a table has been determined, in particular empirically, based on which the maximum permissible microwave power is determined as a function of the convection-relevant parameter and the cooking chamber temperature.

5. The method of claim 1 wherein at least one predetermined threshold value is provided for the convection-relevant parameter, exceeding and/or undershooting the threshold value resulting in a modified dependency of the maximum permissible microwave power.

6. The method of claim 5 wherein the maximum permissible microwave power is determined via the detected cooking chamber temperature and a microwave factor which depends on the at least one predetermined threshold value.

7. The method of claim 1 wherein a temperature limit is provided, the maximum permissible microwave power being zero when the detected cooking chamber temperature reaches the temperature limit.

8. The method of claim 1 wherein the microwave source is operated at most at the maximum permissible microwave power, so that microwaves generated by the microwave source are fed into the cooking chamber and/or that the maximum permissible microwave power is greater than 0% and less than or equal to 100% of the nominal power of the microwave source.

9. The method of claim 1 wherein the maximum permissible microwave power is determined several times during a cooking operation.

10. A combination cooking appliance for cooking a cooking product, the combination cooking appliance having a cooking chamber, a microwave source associated with the cooking chamber for feeding microwaves with a specific microwave power into the cooking chamber, a temperature sensor for detecting a cooking chamber temperature, and at least one sensor for detecting a convection-relevant parameter,
the combination cooking appliance having an evaluation unit which is connected in a signal-transmitting manner to the temperature sensor and to the at least one sensor,
the evaluation unit being set up to determine a maximum permissible microwave power for the microwave source based on the cooking chamber temperature detected by the temperature sensor and the convection-relevant parameter determined by the sensor,
and the combination cooking appliance having a control unit which is connected in a signal-transmitting manner to the evaluation unit and to the microwave source, the control unit being set up to receive the maximum permissible microwave power determined by the evaluation unit and to limit the microwave power of the microwave source on the basis thereof.
